(19) United States
(12) Patent Application Publication
(10) Pub. No.: US 2014/0052546 A1
(43) Pub. Date: Feb. 20, 2014

(54) MULTISCREEN ADAPTIVE RICH MEDIA ADVERTISEMENTS

(71) Applicants: Francis Phan, San Francisco, CA (US); Itai Rabinowitz, San Francisco, CA (US)

(72) Inventors: Francis Phan, San Francisco, CA (US); Itai Rabinowitz, San Francisco, CA (US)

(73) Assignee: YAHOO! INC., Sunnyvale, CA (US)

(21) Appl. No.: 13/585,374

(22) Filed: Aug. 14, 2012

(51) Int. Cl. G06Q 30/02

(52) U.S. Cl. 705/14.72

(57) ABSTRACT

A package of an advertisement's visual elements along with logic for rendering these elements may be provided to a client as part of a single advertisement package. This single package solution may include multiple rendering capabilities depending on the device or the advertisement container. The server side functionality distributes the single advertisement package and the functionality for identifying, selecting, arranging, and displaying the visual elements of the advertisement may be controlled by the logic provided to the client. The advertisement may be dynamically rendered on the client side (e.g. by the web browser) based on the logic that is part of the single advertisement package.

### BACKGROUND

Online advertising may be an important source of revenue for enterprises engaged in electronic commerce. Processes associated with technologies such as Hypertext Markup Language (“HTML”) and Hypertext Transfer Protocol (“HTTP”) enable a web page to be configured to display advertisements (“ads”). Ads may commonly be found on many web sites. Web site publishers, such as news and sports web sites, may provide space for ads, referred to as ad slots or ad containers. The publishers of these web sites may sell advertising space to advertisers to defray the costs associated with operating the web sites as well as to obtain additional revenue.

As the market shifts to accommodate a wider range of computing devices (e.g. smartphones, tablets, netbooks, laptops, desktop computers, etc.) of varying display sizes and varying aspect ratios, the ads that are displayed on those devices must be accommodating of the different sizes. With the proliferation of more web enabled devices (e.g. tablets and smartphones of different sizes), advertisers are faced with increasing challenges in scaling their ads to render on a diversity of screens. An ad that is displayed on a 30 inch monitor will look different on a 3 inch smartphone screen.

Many sites merely resize the ad. However, resizing can result in poor resolution and may not provide the same visual impact on different screens. In particular, the resizing technique may simply visually scale in a uniform matter which breaks down when there are ads with varying aspect ratios. For example, a single ad may be required to adapt from a header ad to a side bar ad of different size, shape, and aspect ratio.

Alternatively, multiple versions of an ad may be implemented and provided over the network depending on the requesting device. For example, mobile ad formats have been proposed to address this fragmentation, but require advertisers to supply multiple versions of the same ad. This process may not scale well, especially for rich media ads that may include dynamic components. Further, processing multiple versions or packages of an ad may require server side processing for identifying the device size and selecting an appropriate version of the ad for that device. Further, multiple versions of the ad must be stored and available/accessible to the server.

### BRIEF DESCRIPTION OF THE DRAWINGS

The system and method may be better understood with reference to the following drawings and description. Non-limiting and non-exhaustive embodiments are described with reference to the following drawings. The components in the drawings are not necessarily to scale, emphasis instead being placed upon illustrating the principles of the invention. In the drawings, like referenced numerals designate corresponding parts throughout the different views.

FIG. 1 is a diagram of an exemplary network system;

FIG. 2 is a diagram of an exemplary advertisement packager;

FIG. 3 is a diagram of exemplary visual elements for an advertisement;

FIG. 4 is an exemplary illustration of visual element;

FIG. 5 is an exemplary arrangement of visual elements in a banner advertisement container;

FIG. 6 is an exemplary arrangement of visual elements in a panel advertisement container;

FIG. 7 is a diagram of exemplary attributes for an advertisement package;

FIG. 8 is an exemplary advertisement with a plurality of visual elements;

FIG. 9 is another exemplary advertisement with a plurality of visual elements;

FIG. 10 is a server side process for generating a single advertisement package; and

FIG. 11 is a client side process for rendering an advertisement from a package.

### DETAILED DESCRIPTION

Subject matter will now be described more fully hereinafter with reference to the accompanying drawings, which form a part hereof, and which show, by way of illustration, specific example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

By way of introduction, a package of an advertisement's individual components (e.g. visual elements) along with logic for rendering these components may be provided to a user or client. The advertisement (“ad”) and components may be rendered client-side using the logic rather than the server dictating the rendering. A single version of an ad that is flexible for different devices would be advantageous. In particular, a single ad package solution may include multiple rendering capabilities depending on the device. The rendering may occur on the client side (e.g. by the web browser) based on logic, information, or instructions that are part of the single ad package. The server side functionality distributes the single ad package without requiring logic for identifying and selecting from multiple versions of an ad. The logic for dynamically rendering the single ad package takes place on the client side.

The ad package may be referred to as utilizing responsive design because the web content renders itself in a meaningful fashion depending on what the dimensions of target display devices are. Accordingly, a responsive ad is the application of responsive design for web advertisements. The rendering may be more than just a simple resizing of an advertisement and may include a dynamic determination of certain conditions that are used for modifying certain elements of the single ad package. Based on those elements, the web browser may optimally render the advertisement for the particular device (e.g. screen size) that is running the web browser.

As described, the single ad package may be referred to as a Multiscreen Adaptive Rich Media Ad (“MARMA”) and may be implemented as a single ad package that can render itself across different screens. The package may support existing ad formats or conform to flexible ad containers (available ad slots in a page) dictated by the content page in which it resides. In particular, the ad package may utilize zones (e.g. “hero” zones described below) of static and dynamic assets to optimally lay out visual elements for target ad formats that have a wide variation of aspect ratios. Likewise, the package may even be adapted to non-conventional or unknown aspect sizes or container sizes. The single ad package solution may include client side rendering logic that does not necessitate the need for additional asset serving.

Although described with respect to advertisements the packaging and rendering techniques displayed may apply to content other than advertisements. The description below regarding the rendering of advertisements through a package is merely one example of content that may be packaged and rendered. Any other content on a page (e.g. web page) may be packaged and rendered utilizing the techniques described.

Other systems, methods, features and advantages will be, or will become, apparent to one with skill in the art upon examination of the following figures and detailed description. It is intended that all such additional systems, methods, features and advantages be included within this description, be within the scope of the invention, and be protected by the following claims. Nothing in this section should be taken as a limitation on those claims. Further aspects and advantages are discussed below.

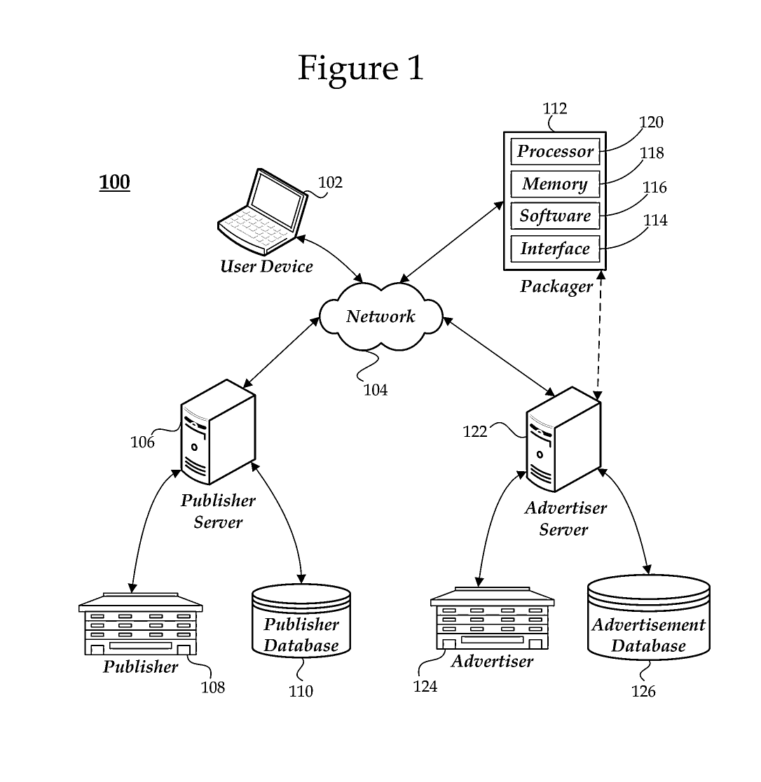

FIG. 1 depicts a block diagram illustrating one embodiment of an exemplary advertising system 100. The advertising system 100 may provide a platform for packaging an advertisement, its visual elements, and logic for rendering the advertisement on different devices. In the advertising system 100, a user device 102 is coupled with a publisher server 106 through a network 104. The publisher server 106 may be operated by and/or coupled with a publisher 108, as well as being coupled with a publisher database 110. An advertiser server 122 coupled with an advertiser 124 may also be coupled with an advertisement database 126. A packager 112 may be coupled with the publisher server 106 and the advertiser server 122. Herein, the phrase “coupled with” is defined to mean directly connected to or indirectly connected through one or more intermediate components. Such intermediate components may include both hardware and software based components. Variations in the arrangement and type of the components may be made without departing from the spirit or scope of the claims as set forth herein. Additional, different or fewer components may be provided. Accordingly, the packager 112 may be coupled through a network (e.g. the network 104) with the advertiser server 122. In alternative embodiments, the packager 112 may be a part of the advertiser server 122.

The user device 102 may be a computing device which allows a user to connect to a network 104, such as the Internet. As described below, the user device 102 may be a third party user who views an advertisement. The user device 102 may also be referred to as a client device and may include a computing device capable of sending or receiving signals, such as via a wired or a wireless network (e.g. the network 104, which may be the Internet). The user device 102 may, for example, include a desktop computer or a portable device, such as a cellular telephone, a smart phone, a display pager, a radio frequency (RF) device, an infrared (IR) device, a Personal Digital Assistant (PDA), a handheld computer, a tablet computer, a laptop computer, a set top box, a wearable computer, an integrated device combining various features, such as features of the forgoing devices, or the like. The user device 102 may vary in terms of capabilities or features, particularly with regard to display size and aspect ratio. The different display sizes and aspect ratios for different user devices may result in an advertisement being rendered differently for those particular user devices. Claimed subject matter is intended to cover a wide range of potential variations. For example, a cell phone may include a numeric keypad or a display of limited functionality, such as a monochrome liquid crystal display (LCD) for displaying text. In contrast, however, as another example, a web-enabled client device may include one or more physical or virtual keyboards, mass storage, one or more accelerometers, one or more gyroscopes, global positioning system (GPS) or other location-identifying type capability, or a display with a high degree of functionality, such as a touch-sensitive color 2D or 3D display, for example.

The user device 102 may include or may execute a variety of operating systems, including a personal computer operating system, such as a Windows, iOS or Linux, or a mobile operating system, such as iOS, Android, or Windows Mobile, or the like. The user device 102 may include or may execute a variety of possible applications, such as a client software application enabling communication with other devices, such as communicating one or more messages, such as via email, short message service (SMS), or multimedia message service (MMS), including via a network, such as a social network, including, for example, Facebook, LinkedIn, Twitter, Flickr, or Google+, to provide only a few possible examples. The user device 102 may also include or execute an application to communicate content, such as, for example, textual content, multimedia content, or the like. The user device 102 may also include or execute an application to perform a variety of possible tasks, such as browsing, searching, playing various forms of content, including locally stored or streamed video, or games (such as fantasy sports leagues). The foregoing is provided to illustrate that claimed subject matter is intended to include a wide range of possible features or capabilities. As described below, the user device 102 executes logic as part of the single ad package for rendering the advertisement optimally based on the display size and aspect ratio of the user device 102.

In one embodiment, the user device 102 is configured to request and receive information from a network (e.g. the network 104, which may be the Internet). The information may include web pages with advertisements. The user device 102 may be configured to access other data/information in addition to web pages over the network 104 using a web browser, such as INTERNET EXPLORER® (sold by Microsoft Corp., Redmond, Wash.) or FIREFOX® (provided by Mozilla). In an alternative embodiment, software programs other than web browsers may also display advertisements received over the network 104 or from a different source. As described below, an advertisement may be rendered and displayed in a web page using logic provided as part of a single advertisement package.

In one embodiment, the publisher server 106 provides an interface to a network 104 and/or provides its web pages over the network, such as to the user device 102. The publisher server 106 may be a web server that provides the user device 102 with pages (including slots or containers for displaying advertisements) that are requested over the network, such as by a user of the user device 102. In particular, the publisher 108 may provide a web page, or a series of web pages that are provided by the publisher server 106 when requested from the user device 102. The publisher server 106 may be operated by a publisher 108 that maintains and oversees the operation of the publisher server 106. The publisher 108 may be any operator of a page displaying advertisements that receives a payment from the advertisers of those advertisements. The publisher 108 may oversee the publisher server 106 by receiving advertisements or single ad packages from an advertiser server 122 that are displayed in pages (e.g. a destination web page) provided by the publisher server 106. In one embodiment, a packager 112 may be used by the publisher 108 to display the advertisement in a web page. As described, the user device 102 may execute logic client-side for rendering and displaying ads, but that is merely one embodiment. Alternatively, the logic of the single ad package may be executed by the publisher server 106 for rendering and arranging the ad (and its visual components) on a page.

The publisher database 110 may be coupled with the publisher server 106 and may store the publisher's pages or data that is provided by the publisher server 106. The pages that are stored may have ad slots or containers for displaying advertisements. The containers may be different shapes, sizes, and orientation. Further, depending on the user device that the page is rendered for, the size may be further modified. The container size and display size may be used as part of the single ad package logic for dynamically rendering and rearranging visual elements of the ad. In one embodiment, the publisher database 110 may store advertisements from a number of advertisers, such as the advertiser 124. In addition, the publisher database 110 may store information related to the ad container size, shape and orientation for different pages. The logic that is included with a single ad package may reference this stored information in order to handle as many different sizes and orientations as possible.

The advertiser server 122 may provide advertisements for display in web pages, such as the publisher's pages. In one embodiment, the advertiser server 122 is coupled with the publisher server 106 for providing ads on the publisher's web pages. The advertiser 124 may be any operator of the advertiser server 122 for providing advertisements. The advertisements may relate to products and/or services provided by the advertiser 124. The publisher server 106 and/or the advertiser server 122 may be one or more computing devices which may be capable of sending or receiving signals, such as via a wired or wireless network, or may be capable of processing or storing signals, such as in memory as physical memory states, and may, therefore, operate as a server. Thus, devices capable of operating as a server may include, as examples, dedicated rack-mounted servers, desktop computers, laptop computers, set top boxes, integrated devices combining various features, such as two or more features of the foregoing devices, or the like. Servers may vary widely in configuration or capabilities, but generally a server may include one or more central processing units and memory. A server may also include one or more mass storage devices, one or more power supplies, one or more wired or wireless network interfaces, one or more input/output interfaces, or one or more operating systems, such as Windows Server, Mac OS X, Unix, Linux, FreeBSD, or the like.

In addition, the publisher server 106 and/or the advertiser server 122 may be or may be part of a content server. A content server may include a device that includes a configuration to provide content via a network to another device. A content server may, for example, host a site, such as a social networking site, examples of which may include, without limitation, Flicker, Twitter, Facebook, LinkedIn, or a personal user site (such as a blog, vlog, online dating site, etc.). A content server may also host a variety of other sites, including, but not limited to business sites, educational sites, dictionary sites, encyclopedia sites, wikis, financial sites, government sites, etc. A content server may further provide a variety of services that include, but are not limited to, web services, third-party services, audio services, video services, email services, instant messaging (IM) services, SMS services, MMS services, FTP services, voice over IP (VOIP) services, calendaring services, photo services, or the like. Examples of content may include text, images, audio, video, or the like, which may be processed in the form of physical signals, such as electrical signals, for example, or may be stored in memory, as physical states, for example. Examples of devices that may operate as a content server include desktop computers, multiprocessor systems, microprocessor-type or programmable consumer electronics, etc.

The packager 112 may create a single ad package that includes the visual elements that make up an ad, as well as the logic for rendering the ad for different ad containers and different displays. The logic may be executed by the user device 102 or publisher server 106 for rearranging the visual elements of the ad. In one embodiment, the packager 112 may be controlled by the advertiser 124 and may be a part of the advertiser server 122, or may be part of a separate entity. The packager 112 may receive advertisements from a number of different advertisers, such as the advertiser 124 and may individually package ads and generate logic for those ads.

The packager 112 may be a computing device for generating logic for rendering visual elements of an ad. The packager 112 may include a processor 120, memory 118, software 116 and an interface 114. The packager 112 may be a separate component from the publisher server 106 and/or the advertiser server 122, or may be combined as a single component or device.

The interface 114 may communicate with any of the user device 102, the publisher server 106, and/or the advertiser server 122. The interface 114 may include a user interface configured to allow a user and/or administrator to interact with any of the components of the packager 112. For example, the administrator and/or user may be able to program the logic for rendering and rearranging visual elements of the ad.

The processor 120 in the packager 112 may include a central processing unit (CPU), a graphics processing unit (GPU), a digital signal processor (DSP) or other type of processing device. The processor 120 may be a component in any one of a variety of systems. For example, the processor 120 may be part of a standard personal computer or a workstation. The processor 120 may be one or more general processors, digital signal processors, application specific integrated circuits, field programmable gate arrays, servers, networks, digital circuits, analog circuits, combinations thereof, or other now known or later developed devices for analyzing and processing data. The processor 120 may operate in conjunction with a software program, such as code generated manually (i.e., programmed).

The processor 120 may be coupled with a memory 118, or the memory 118 may be a separate component. The interface 114 and/or the software 116 may be stored in the memory 118. The memory 118 may include, but is not limited to, computer readable storage media such as various types of volatile and non-volatile storage media, including random access memory, read-only memory, programmable read-only memory, electrically programmable read-only memory, electrically erasable read-only memory, flash memory, magnetic tape or disk, optical media and the like. The memory 118 may include a random access memory for the processor 120. Alternatively, the memory 118 may be separate from the processor 120, such as a cache memory of a processor, the system memory, or other memory. The memory 118 may be an external storage device or database for storing recorded ad or user data. Examples include a hard drive, compact disc (“CD”), digital video disc (“DVD”), memory card, memory stick, floppy disc, universal serial bus (“USB”) memory device, or any other device operative to store ad or user data. The memory 118 is operable to store instructions executable by the processor 120.

The functions, acts or tasks illustrated in the figures or described herein may be performed by the programmed processor executing the instructions stored in the memory 118. The functions, acts or tasks are independent of the particular type of instruction set, storage media, processor or processing strategy and may be performed by software, hardware, integrated circuits, firm-ware, micro-code and the like, operating alone or in combination. Likewise, processing strategies may include multiprocessing, multitasking, parallel processing and the like. The processor 120 is configured to execute the software 116. The software 116 may include instructions for generating logic for client-side rendering of ads that can be included with a single ad package.

The interface 114 may be a user input device or a display. The interface 114 may include a keyboard, keypad or a cursor control device, such as a mouse, or a joystick, touch screen display, remote control or any other device operative to interact with the packager 112. The interface 114 may include a display coupled with the processor 120 and configured to display an output from the processor 120. The display may be a liquid crystal display (LCD), an organic light emitting diode (OLED), a flat panel display, a solid state display, a cathode ray tube (CRT), a projector, a printer or other now known or later developed display device for outputting determined information. The display may act as an interface for the user to see the functioning of the processor 120, or as an interface with the software 116 for providing input parameters.

The present disclosure contemplates a computer-readable medium that includes instructions or receives and executes instructions responsive to a propagated signal, so that a device connected to a network can communicate voice, video, audio, images or any other data over a network. The interface 114 may be used to provide the instructions over the network via a communication port. The communication port may be created in software or may be a physical connection in hardware. The communication port may be configured to connect with a network, external media, display, or any other components in system 100, or combinations thereof. The connection with the network may be a physical connection, such as a wired Ethernet connection or may be established wirelessly as discussed below. Likewise, the connections with other components of the system 100 may be physical connections or may be established wirelessly. Any of the components in the advertising system 100 may be coupled with one another through a network, including but not limited to the network 104. For example, the packager 112 may be coupled with the publisher server 106 and/or the advertiser server 122 through a network. As another example, the advertiser database 126 may be coupled with the publisher server 106 and/or the packager 112 through a network. Accordingly, any of the components in the advertising system 100 may include communication ports configured to connect with a network, such as the network 104.

The network (e.g. the network 104) may couple devices so that communications may be exchanged, such as between a server and a client device or other types of devices, including between wireless devices coupled via a wireless network, for example. A network may also include mass storage, such as network attached storage (NAS), a storage area network (SAN), or other forms of computer or machine readable media, for example. A network may include the Internet, one or more local area networks (LANs), one or more wide area networks (WANs), wire-line type connections, wireless type connections, or any combination thereof. Likewise, sub-networks, such as may employ differing architectures or may be compliant or compatible with differing protocols, may interoperate within a larger network. Various types of devices may, for example, be made available to provide an interoperable capability for differing architectures or protocols. As one illustrative example, a router may provide a link between otherwise separate and independent LANs. A communication link or channel may include, for example, analog telephone lines, such as a twisted wire pair, a coaxial cable, full or fractional digital lines including T1, T2, T3, or T4 type lines, Integrated Services Digital Networks (ISDNs), Digital Subscriber Lines (DSLs), wireless links including satellite links, or other communication links or channels, such as may be known to those skilled in the art. Furthermore, a computing device or other related electronic devices may be remotely coupled to a network, such as via a telephone line or link, for example.

A wireless network may couple client devices with a network. A wireless network may employ stand-alone ad-hoc networks, mesh networks, Wireless LAN (WLAN) networks, cellular networks, or the like. A wireless network may further include a system of terminals, gateways, routers, or the like coupled by wireless radio links, or the like, which may move freely, randomly or organize themselves arbitrarily, such that network topology may change, at times even rapidly. A wireless network may further employ a plurality of network access technologies, including Long Term Evolution (LTE), WLAN, Wireless Router (WR) mesh, or 2nd, 3rd, or 4th generation (2G, 3G, or 4G) cellular technology, or the like. Network access technologies may enable wide area coverage for devices, such as client devices with varying degrees of mobility, for example. For example, a network may enable RF or wireless type communication via one or more network access technologies, such as Global System for Mobile communication (GSM), Universal Mobile Telecommunications System (UMTS), General Packet Radio Services (GPRS), Enhanced Data GSM Environment (EDGE), 3GPP Long Term Evolution (LTE), LTE Advanced, Wideband Code Division Multiple Access (WCDMA), Bluetooth, 802.11b/g/n, or the like. A wireless network may include virtually any type of wireless communication mechanism by which signals may be communicated between devices, such as a client device or a computing device, between or within a network, or the like.

Signal packets communicated via a network, such as a network of participating digital communication networks, may be compatible with or compliant with one or more protocols. Signaling formats or protocols employed may include, for example, TCP/IP, UDP, DECnet, NetBEUI, IPX, Appletalk, or the like. Versions of the Internet Protocol (IP) may include IPv4 or IPv6. The Internet refers to a decentralized global network of networks. The Internet includes local area networks (LANs), wide area networks (WANs), wireless networks, or long haul public networks that, for example, allow signal packets to be communicated between LANs. Signal packets may be communicated between nodes of a network, such as, for example, to one or more sites employing a local network address. A signal packet may, for example, be communicated over the Internet from a user site via an access node coupled to the Internet. Likewise, a signal packet may be forwarded via network nodes to a target site coupled to the network via a network access node, for example. A signal packet communicated via the Internet may, for example, be routed via a path of gateways, servers, etc. that may route the signal packet in accordance with a target address and availability of a network path to the target address.

The network connecting the devices described above (e.g. the network 104) may be a “content delivery network” or a “content distribution network” (CDN). For example, the publisher server 106 and/or the advertiser server 122 may be part of a CDN. A CDN generally refers to a distributed content delivery system that comprises a collection of computers or computing devices linked by a network or networks. A CDN may employ software, systems, protocols or techniques to facilitate various services, such as storage, caching, communication of content, or streaming media or applications. Services may also make use of ancillary technologies including, but not limited to, “cloud computing,” distributed storage, DNS request handling, provisioning, signal monitoring and reporting, content targeting, personalization, or business intelligence. A CDN may also enable an entity to operate or manage another's site infrastructure, in whole or in part.

Likewise, the network connecting the devices described above (e.g. the network 104) may be a peer-to-peer (or P2P) network that may employ computing power or bandwidth of network participants in contrast with a network that may employ dedicated devices, such as dedicated servers, for example; however, some networks may employ both as well as other approaches. A P2P network may typically be used for coupling nodes via an ad hoc arrangement or configuration. A peer-to-peer network may employ some nodes capable of operating as both a “client” and a “server.” For example, the ad server 122 or the publisher server 106 may provide advertisements and/or content to the user device 102 over a P2P network, such as the network 104.

The publisher server 106, the publisher database 110, the packager 112, the advertiser server 122, the advertiser database 126, and/or the user device 102 may represent computing devices of various kinds. Such computing devices may generally include any device that is configured to perform computation and that is capable of sending and receiving data communications by way of one or more wired and/or wireless communication interfaces, such as interface 114. For example, the user device 102 may be configured to execute a browser application that employs HTTP to request information, such as a web page, from the publisher server 106. The present disclosure contemplates the use of a computer-readable medium that includes instructions or receives and executes instructions responsive to a propagated signal, so that any device connected to a network can communicate voice, video, audio, images or any other data over a network.

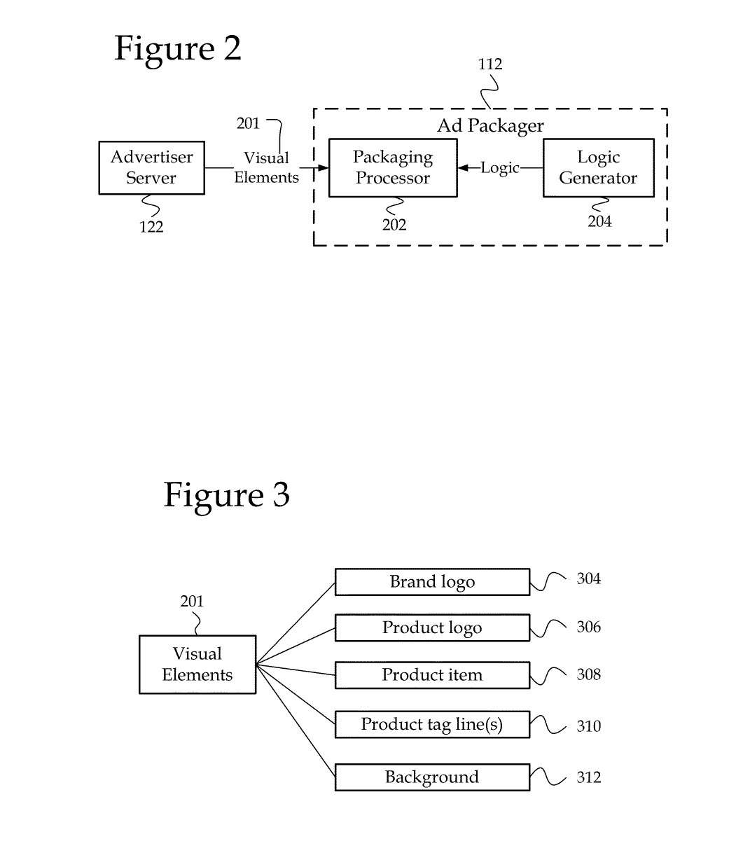

FIG. 2 is a diagram of an exemplary packager 112. The packager 112 may include a packaging processor 202, which may include or be the same as the processor 120 discussed above. The packager 112 may further include a logic generator 204. The advertiser server 122 may provide an advertisement along with its visual elements 201 to the ad packager 112. Exemplary visual elements 201 are described with respect to FIG. 3. The packaging processor 202 receives the visual elements 201 along with logic from the logic generator 204 as part of a single ad package that can be provided to a client or user device.

The logic may include Hypertext Markup Language (“HTML”) (e.g. HTML5), JavaScript, or Cascading Style Sheets (“CSS”) (e.g. CSS3), which may be utilized on the client side for rendering and displaying the advertisement from the single ad package. In one embodiment, HTML5, CSS3, or JavaScript may be client side logic for rendering the ad. Alternatively, HTML5, CSS3, or JavaScript may implement client-side logic that does the rendering. Other mechanisms may be utilized for rendering the ad on the client side and HTML5, JavaScript, and CSS3 are merely exemplary.

The ad designer may define CSS media queries or Javascript code equivalent to determine what ad formats/containers to support. For each of the ad formats, the designer positions and scales each of the visual elements 201. In one example, a CSS media query may be utilized for rendering an ad package in which each visual element may be selected, scaled, and translated independently. An exemplary CSS media query may include:

/* 768x90 N */
@media screen and (min-width:801px) {

.ad_stage {

width:768px;
height:90px;
left: 40px;
top: 60px;

}
#videoelem {

left:390px;
top:−75px;
-webkit-transform:scale(.8);

}
#life_is_a_sport {

-webkit-transform:scale(.8);
left:40px;
top:5px;

}
#make_it_count {

-webkit-transform:scale(.8);
left:200px;
top:5px;

}
#nike_logo {

-webkit-transform:scale(.8);
left:170px;
top:30px;

}
#fuelband_logo {

-webkit-transform:scale(1.2);
top:30px;
left:100px;

}

}

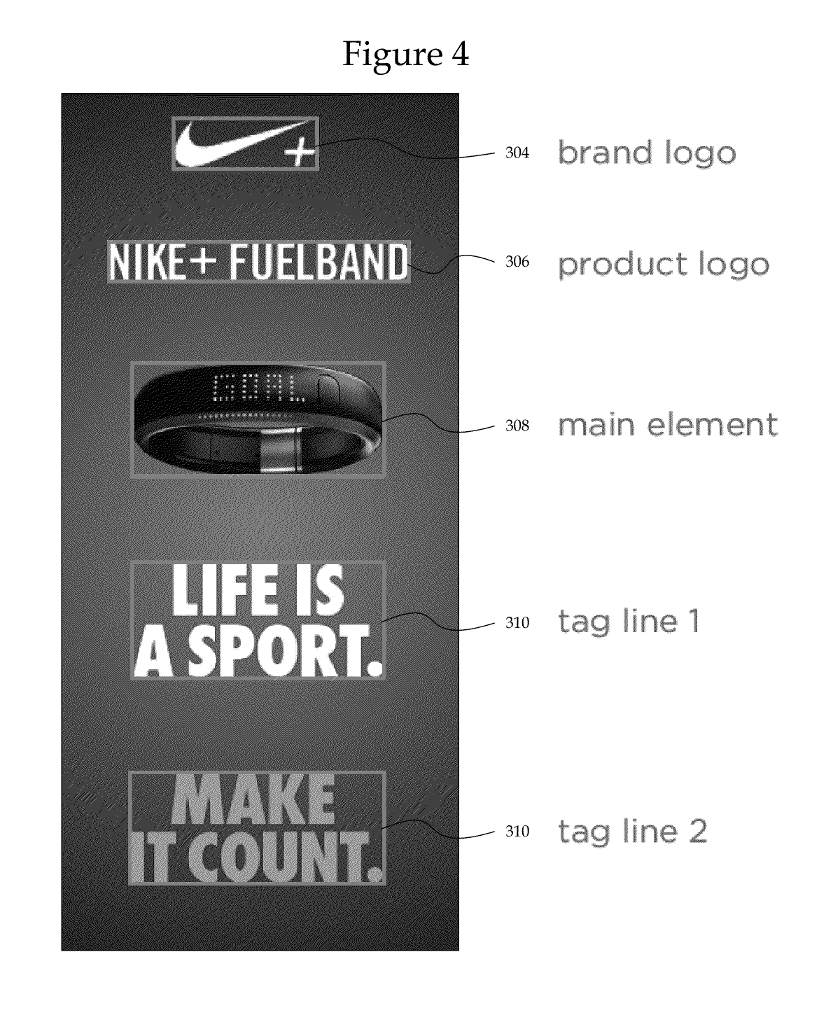

The logic may be utilized for organizing the visual elements of the ad as shown in FIGS. 4-6 and 8-9. The logic may identify a device display size or aspect ratio, as well as an ad container/slot size and aspect ratio. Based on the size information, the visual elements may be selected, organized and sized. The ad server only needs to provide a single ad package that includes this logic in order for the ad to be rendered effectively on many different platforms and devices. Accordingly, the ad server does not need to know any information about the user device display for the ad to still be displayed for that user.

FIG. 3 is a diagram of exemplary visual elements 201 for an ad. The visual elements 201 may include a brand logo 304 that identifies or displays the brand, a product logo 306 that identifies or displays the product logo, a product item 308 that displays the product, a product tag line(s) 310 that describes the product, and a background 312 on which the ad is displayed.

FIG. 4 is an exemplary illustration of visual elements 201. In particular, FIG. 4 illustrates examples of the visual elements 201 from FIG. 3. The brand logo 304 and product logo 306 are shown as independent elements. The main element is the product item 308 that displays the product being advertised. FIG. 4 illustrates two examples of tag lines 310.

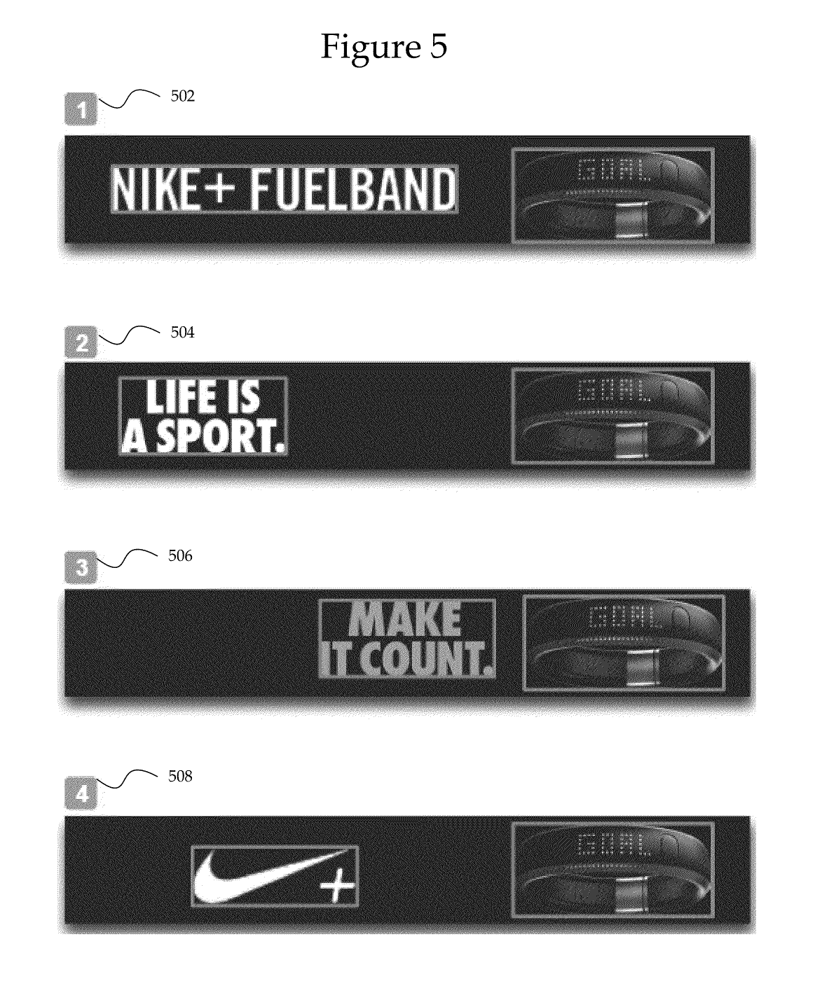

FIG. 5 is an exemplary arrangement of visual elements 201 in a banner advertisement container. In particular, FIG. 5 illustrates four embodiments in which visual elements 201 are organized and arranged for a banner advertisement. As shown, the ad container for each embodiment in FIG. 5 is the same, but in other embodiments, the size and shape of the ad container may be used to determine which visual elements are included and how they are arranged. In the first embodiment 502, the product logo 306 is shown next to the product item 308. In the second embodiment 504, a first tag line 310 is shown left-aligned relative to the product item 308. In the third embodiment 506, a second tag line 310 is shown right-aligned next to the product item 308. In the fourth embodiment 508, a brand logo 304 is shown next to the product item 308. Alternate arrangements may be available and controlled by the logic provided with the single ad package. The logic may provide for different options depending on size or based on popularity or success of different combinations. For example, when ad views/clicks/conversions are monitored for the ad, there may be certain combinations that are more successful, which may then be used for modifying the logic for targeting. For example, maybe embodiment 502 has a 10% click through rate while the other embodiments are below 1%, in which case the embodiment 502 may be preferred.

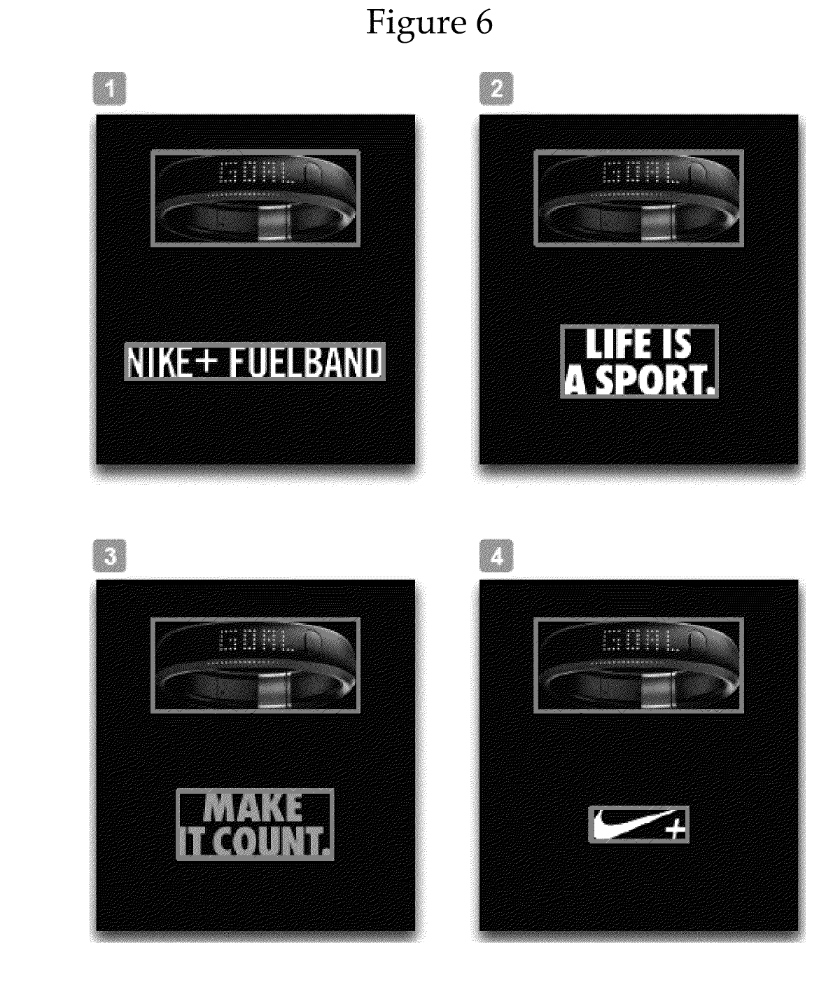

FIG. 6 is an exemplary arrangement of visual elements 201 in a panel advertisement container. In particular, FIG. 6 illustrates four embodiments in which visual elements 201 are organized and arranged for a side panel advertisement. As described with respect to FIG. 5, different visual elements 201 may be chosen and arranged for the ad. Compared with FIG. 5, the arrangement of the visual elements 201 is to have the product item 308 on top with another element underneath, whereas for the banner ad, the product item 308 was on the side of another element. This arrangement is selected based on the ad container (e.g. banner or side panel). There may be many more sizes and shapes of ad containers that are considered in the logic for arranging one or more visual elements.

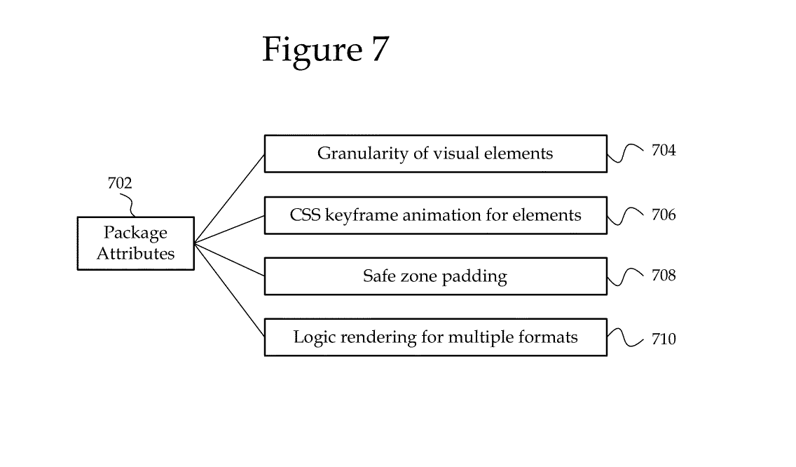

FIG. 7 is a diagram of exemplary attributes 702 for an advertisement package. The attributes 702 may be considerations by the logic for how the visual elements 201 are arranged and the ad is rendered. The granularity 704 of foreground visual elements 201 may refer to the interchangeability of the elements. These visual elements 201 may have transparent backgrounds that can be scaled, translated, rotated or transformed. As the visual elements 201 are separated, as opposed to being already composited, each of their attributes can be modified independently and appropriately to maximize visual aesthetics and legibility of each element. In one embodiment, there may be a CSS keyframe animation 704 as one of the visual elements 201. In particular, where all foreground elements cannot physically appear concurrently without obscuring each other and to maintain visual aesthetics and legibility, their appearance may be staggered in time through CSS keyframe animations. The most prominent image asset of interest should have safe zone padding 708 between 20 to 30 percent. This may be referred to as the “hero” portion of the image. The hero portion may also be referred as a safe zone that includes important features of the image, such as branding, product details, or other text that should not be cropped. Accordingly, the hero portion may be a portion of the image that should not be cropped and should be always guaranteed to be in view. In one embodiment, the hero portion may be useful for smartphones or tablet devices where turning the device from portrait to landscape also turns the displayed image. Accordingly, the image may be cropped in the transition between portrait and landscape rather than just resizing. In other words, a safe zone portion allows for creative truncation of the image for extreme aspect ratios of the parent ad container. This rule may also apply to a background image. The logic can render for multiple formats 710, which is illustrated in FIGS. 5-6 and 8-9.

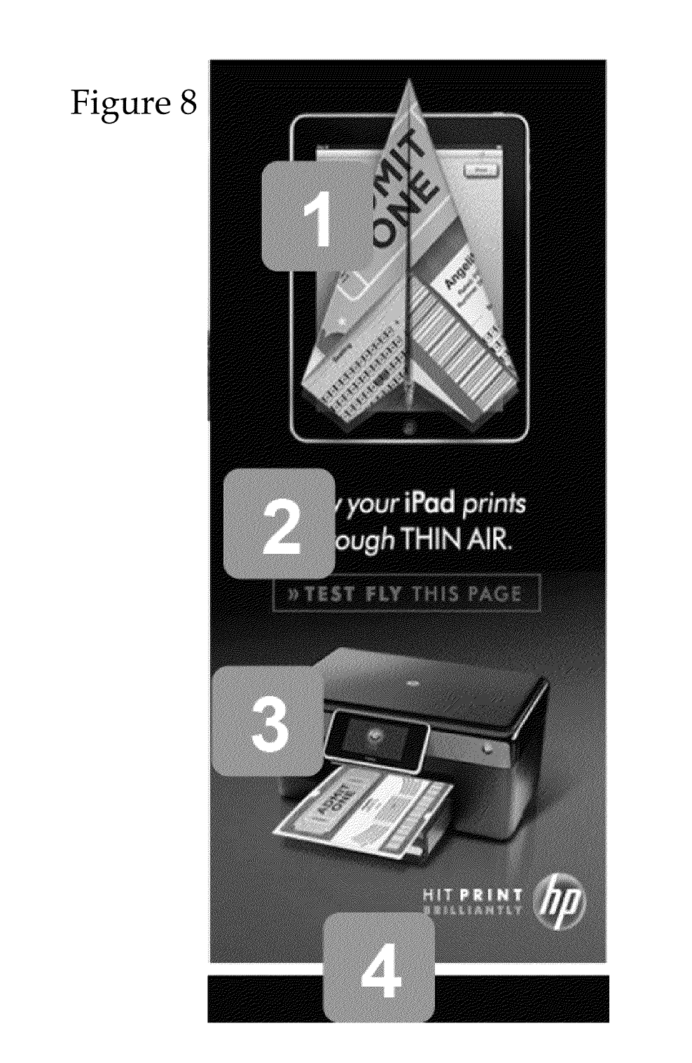

FIG. 8 is an exemplary advertisement with a plurality of visual elements 201. The visual elements 201 are not labeled (as in FIGS. 3-4) but are instead referred to by the numbers 1-4 shown on FIG. 8. In particular, FIG. 8 illustrates a vertical orientation ad in which visual elements 1-4 are arranged from top to bottom.

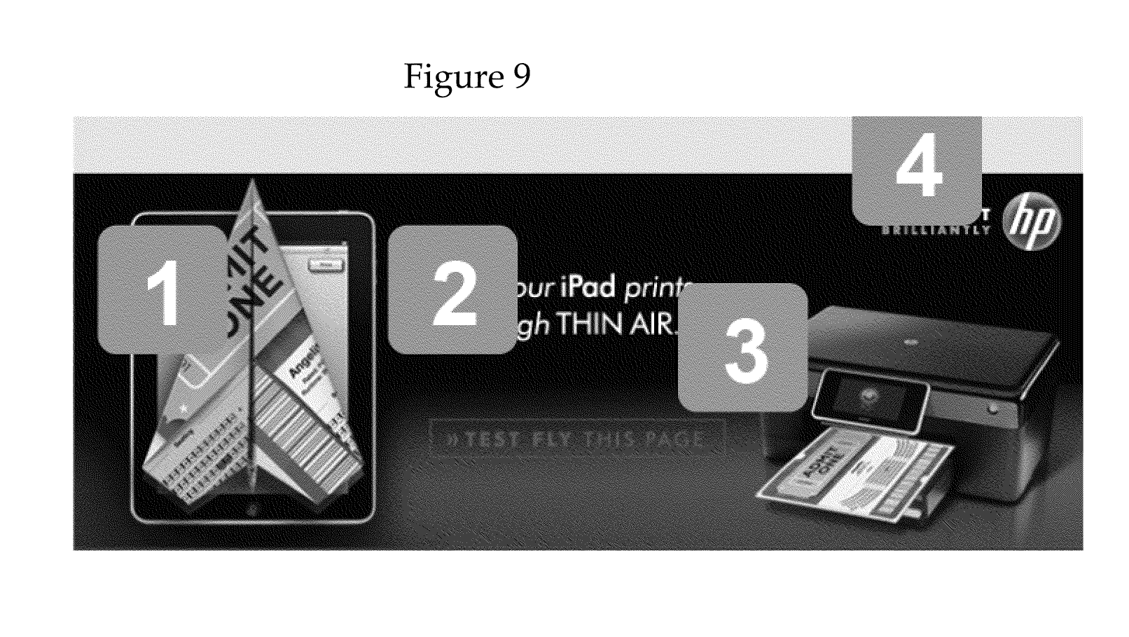

FIG. 9 is another exemplary advertisement with a plurality of visual elements 201. Compared with FIG. 8, FIG. 9 illustrates a horizontal orientation ad in which visual elements 1-4 are arranged from the left to right. Accordingly, FIGS. 8-9 illustrate that a single ad package that includes the visual elements 1-4 may be rendered for multiple ad container sizes: vertical as in FIG. 8 and horizontal as in FIG. 9.

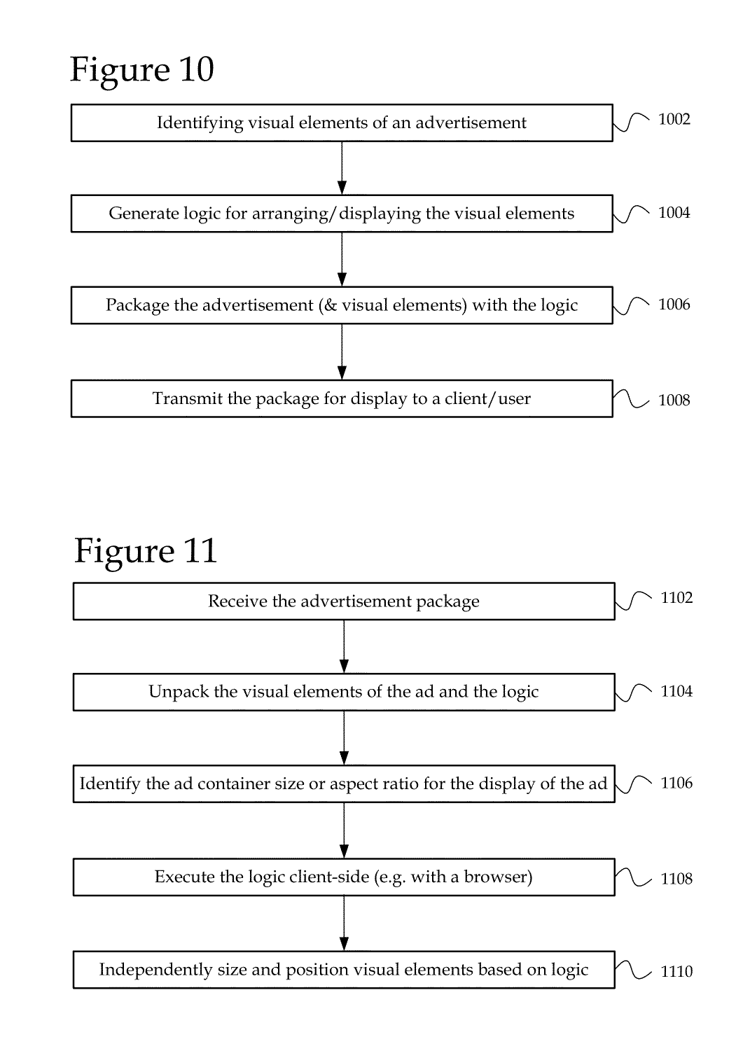

FIG. 10 is a server side process for generating a single advertisement package. In block 1002, visual elements of an ad are identified. As described, references to the ad may refer to the visual elements that make up the ad. In block 1004, logic for arranging and displaying the visual elements is generated. In particular, the logic may be executed client side for displaying the ad on the user device. The logic may optimally arrange the identified visual elements based on the ad container size and the display size and aspect ratio of the user device. In block 1006, the advertisement, including its visual elements, is packaged with the logic. The package may be referred to as a single ad package and may be transmitted to the user device for display as in block 1008. The user device executes the logic for instructions on how to arrange the visual elements.

FIG. 11 is a client side process for rendering an advertisement from a package. In alternative embodiments, the ad may be rendered by the publisher rather than the client. The ad server provides logic for the rendering of the ad at the client or publisher. In block 1102, the ad package is received from the ad server. In block 1104, the ad package is unpacked such that the visual elements and the logic are identified. In block 1106, the ad container size and/or aspect ratio and display size are identified for the location where the ad will be displayed. The logic is executed client-side on the user device in block 1108. The visual elements are independently sized and positioned based on the logic in block 1110. The logic may utilize the ad container size and/or aspect ratio and display size of the user device for optimally selecting, positioning, and sizing the visual elements for display.

A “computer-readable medium,” “machine readable medium,” “propagated-signal” medium, and/or “signal-bearing medium” may comprise any device that includes, stores, communicates, propagates, or transports software for use by or in connection with an instruction executable system, apparatus, or device. The machine-readable medium may selectively be, but not limited to, an electronic, magnetic, optical, electromagnetic, infrared, or semiconductor system, apparatus, device, or propagation medium. A non-exhaustive list of examples of a machine-readable medium would include: an electrical connection “electronic” having one or more wires, a portable magnetic or optical disk, a volatile memory such as a Random Access Memory “RAM”, a Read-Only Memory “ROM”, an Erasable Programmable Read-Only Memory (EPROM or Flash memory), or an optical fiber. A machine-readable medium may also include a tangible medium upon which software is printed, as the software may be electronically stored as an image or in another format (e.g., through an optical scan), then compiled, and/or interpreted or otherwise processed. The processed medium may then be stored in a computer and/or machine memory.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

We claim:

1. A system for providing an advertisement over a network, the system comprising:
an advertiser server for providing the advertisement that comprises a plurality of visual elements;
a logic generator for generating logic that is executable upon receipt of the advertisement, wherein the logic provides instructions for arranging the visual elements depending on a display size; and
a packaging processor for packaging the advertisement and the logic for transmission over the network.

2. The system of claim 1 wherein the packaged advertisement and logic is received by a user device over the network.

3. The system of claim 2 wherein the logic is executed by the user device for display on the user device.

4. The system of claim 3 wherein the user device includes a browser for viewing pages, wherein the pages include at least one advertisement container for displaying the advertisement.

5. The system of claim 4 wherein the logic arranges the visual elements based on the advertisement container size or aspect ratio.

6. The system of claim 4 wherein the browser executes the logic.

7. The system of claim 6 wherein the logic is implemented with one of Hypertext Markup Language (“HTML”), JavaScript, or Cascading Style Sheets (“CSS”).

8. The system of claim 1 wherein the visual elements comprise at least one of a brand logo, product logo, product item, product tag line, or background.

9. A method for providing an advertisement comprising a plurality of visual elements for display, the method comprising:
generating, with at least one processor, client executable logic for rearranging the visual elements based on how the advertisement will be displayed; and
packaging the client executable logic with the visual elements for transmission over a network.

10. The method of claim 9 wherein the transmission of the packaged logic and visual elements is provided to a client device for displaying the advertisement upon executing the client executable logic.

11. The method of claim 10, wherein the visual elements are rearranged based on a size or aspect ratio of an either an advertisement container or the client device.

12. The method of claim 9 wherein the client executable logic further identifies the visual elements for display in addition to an arrangement of the identified visual elements.

13. A system for advertisement rendering comprising:
a publisher server for providing a page that includes at least one advertisement container for displaying the advertisement;
an advertisement server for providing visual elements of the advertisement; and
a packager coupled with the advertisement server that combines logic with the visual elements of the advertisement in a single advertisement package that is transmitted to the display device, wherein the logic selects and arranges the visual elements based on the at least one advertisement container upon execution.

14. The system of claim 13 wherein the logic is executed by the publisher server upon inclusion of the advertisement on the page.

15. The system of claim 13 wherein the logic is executed by a display device that displays the page and the advertisement.

16. The system of claim 15 wherein the display device includes a browser for viewing the page that executes the logic.

17. The system of claim 16 wherein the logic is implemented with one of Hypertext Markup Language (“HTML”), JavaScript, or Cascading Style Sheets (“CSS”).

18. The system of claim 13 wherein the visual elements comprise at least one of a brand logo, product logo, product item, product tag line, or background.

19. A non-transitory computer readable medium having stored therein data representing instructions executable by a programmed processor for displaying content in a page, the storage medium comprising instructions operative for:
identifying visual elements of the content to display in the page;
combining the visual elements with executable logic, wherein the executable logic arranges the visual elements for display based on a container size that displays the content; and
transmitting the combined visual elements and the executable logic for display upon execution of the executable logic, wherein the executable logic is executed when the content is added to the page.

20. The computer readable medium of claim 19 wherein the content comprises an advertisement, the container comprises an advertisement container, and the page comprises a web page that is displayed on a web browser, further wherein the web browser executes the executable logic and the arrangement of the visual elements is established by the executable code.
